(19) United States
(12) Patent Application Publication
(10) Pub. No.: US 2021/0086250 A1
(43) Pub. Date: Mar. 25, 2021

(54) METHOD FOR OPERATING A PROCESSING INSTALLATION WITH A MOVABLE PUNCH

(71) Applicant: Christian Donhauser, Wiggensbach (DE)

(72) Inventors: Maximilian Lorenz, Wolfertschweden (DE); Matthias Menzl, Fussen (DE); Michael Layh, Altusried (DE); Christian Donhauser, Wiggensbach (DE); Bernd Pinzer, Kempten (DE)

(21) Appl. No.: 16/630,817

(22) PCT Filed: Jun. 13, 2018
(86) PCT No.: PCT/EP2018/065683

§ 371 Date: Jan. 13, 2020

(30) Foreign Application Priority Data
Jul. 18, 2017 (DE) 10 2017 212 253.6

(51) Int. Cl. B21D 28/16; B21D 28/26; B21D 28/34; B26D 5/00; G01N 21/95; G01B 11/06

(52) U.S. Cl. CPC B21D 28/16; B21D 28/265; B21D 28/34; B26F 2001/4472; G01N 21/9515; G01B 11/0608; B26D 5/007

(57) ABSTRACT

The invention relates to a method for operating a processing installation (1) including a first processing machine (2), the first processing machine (2) comprising at least one movable punch (5) for separating, preferably punching or punch broaching, a workpiece (8), the method comprising the following steps:
contactlessly, preferably optically, detecting a contour of a cut surface produced on the workpiece (8) by the punch (5) by means of at least one sensor unit (12) mounted on the processing installation (1), wherein the detecting is performed in-line in the processing installation (1) and consequently without removing the workpiece (8) from the processing installation (1), and
evaluating the condition of the cut surface on the basis of the data detected by the sensor unit (12).

The invention relates to a method for operating a processing installation having a movable punch. A workpiece is separated using the punch, in particular by punching or punch broaching.

The processing installation considered here comprises at least one processing machine with a movable punch for separating, preferably punching or punch broaching, a workpiece. The processing machine separates, for example, a sheet into at least one punched strip and at least one punched piece. In the prior art, the punched strip or the punched piece is removed from the processing installation for evaluating the condition of the cut surface produced. The examination of the cut surface is therefore performed outside the processing installation and not in synchronization with the operating processing installation. The situation is similar for the evaluation of the condition of the cutting edge of the punch. In the prior art, the punch is also removed from the processing machine for examination.

It is an object of the invention to provide a method for operating a processing installation, said method allowing the processing installation to produce high-quality components.

This object is achieved by the features of the independent claims. The dependent claims include advantageous embodiments of the invention.

The object is thus achieved by a method for operating a processing installation including a first processing machine. The first processing machine comprises at least one movable punch for separating, preferably punching or punch broaching, a workpiece. The “processing installation” comprises at least the first processing machine described here, but may also include further processing machines, for example for bending, tapping, thread forming, milling, drilling and/or turning, and/or further elements, for example for transporting the workpiece within the processing installation.

The term “workpiece” is used here as a generic term for the base material (for example, sheet metal), the punched strip and the punched piece. The workpiece is separated using the at least one punch of the first processing machine. If the punch is configured for punching, the workpiece is separated into punched strip and punched piece.

However, in the context of the present invention, punch broaching is also counted among the separating methods with a punch. In punch broaching, the cut surface is post-processed after punching with a punch with an appropriate cutting edge. If the punch is configured for punch broaching, the “separation” into chips and punched strips or punched piece occurs. The cutting edge for punch broaching may be located on the same punch that carries out punching. Furthermore, it is possible to use a separate punch for punch broaching. The same or similar processing machines as for punching are used for punch broaching. The published patent application DE 199 48 857 A1 shows an example device for punch broaching.

Within the scope of the method according to the invention, a non-contact detection of the contour of the cut surface on the workpiece is performed using at least one sensor unit. This contour on the workpiece is produced by the punch. The cut surface is either on the punched strip or on the punched piece. The contour of the cut surface is preferably detected using an optical method. Possible optical methods for detecting the contour will be described in detail.

According to the invention, the detection takes place “in-line” in the processing installation. The cut surface is thus detected without removing the workpiece (punched strip or punched piece) with the cut surface to be detected from the processing installation.

In a simple embodiment, the “processing installation” comprises only the first processing machine, in particular along with a transport means for feeding the workpiece into the processing machine and for removing the workpiece (punched strip and/or punched piece) from the processing machine. In addition, the processing installation may also comprise other downstream processing machines. It is crucial that, within the “processing installation” defined herein, the punched strip and the punched piece are moved in orderly fashion and synchronized with the punch. As long as these elements are in order and are moved synchronized or rest between two clocked movements, they are by definition within the “processing installation”. As soon as the punched strip or the punched piece leave the clocked flow and/or, for example, are fed to a bulk material store, they leave the “processing installation”. The detection of the contour of the cut surface according to the invention takes place within the “processing installation” defined herein and thus in-line with the production flow.

Also, a plurality of sensor units may be used to detect the cut surface both on the punched strip and on the punched piece. Furthermore, it is also taken into consideration to detect the cut surface on the punched strip with a plurality of sensor units. It is also possible to detect the cut surface on the punched piece with a plurality of sensor units.

After the detection of the contour of the cut surface, the condition of the cut surface is evaluated based on the data detected by the sensor unit. Based on the evaluated condition of the cut surface, different conclusions can be drawn: for example, it is possible to assess the quality of the parts produced based on the cut surface, leading, for example, to the removal of individual parts. Furthermore, it is contemplated to infer the quality of the cutting edge of the punch based on the cut surface. Thereby, wear of the cutting edge may be determined. Furthermore, the processing installation or the processing machine may be controlled differently based on the condition of the cut surface: for example, the cycle of the processing machine may be changed. The in-line measurement according to the invention makes it possible to determine the condition of the cut surface during production with the processing installation, to draw the conclusions described and to take appropriate measures in-line.

It is particularly preferred to evaluate the data detected with the at least one sensor unit in a computing unit. The processing installation, in particular the first processing machine, is particularly preferably controlled by the computing unit and based on the evaluated condition of the cut surface.

It is preferred that the sensor unit detects the contour of the cut surface synchronized with the movement of the punch performing the separation. The sensor unit thus detects the workpiece while it is moving synchronizedly and/or between two clocked movements. The punch of the first processing machine is moved, for example, at a rate of 50 per minute or faster. Particularly preferably, the sensor unit detects the contour at least every 100th cycle, preferably at least every 50th cycle, particularly preferably at least every 10th cycle, further preferably at least every cycle.

In particular, the following is contemplated for the detection of the cut surface on the punched strip: The workpiece is transported through the first processing machine in the processing installation using a transport means. After the first processing machine, the punched strip is transported to another processing machine or to an end of the processing installation. The sensor unit detects the contour of the cut surface while the punched strip is moved by means of the transport means and/or rests on the transport means between two clocked movements. The punched strip is therefore not removed from the transport means in order to carry out the detection of the cut surface.

In principle, the at least one sensor unit may be arranged fixedly or movably within the processing installation. If the sensor unit is arranged fixedly, the workpiece preferably moves past the sensor unit when the cut surface is detected. If the sensor unit is arranged movably, the workpiece may stand still or also move when the cut surface is detected.

According to an embodiment, the sensor unit is moved to detect the cut surface. In particular, this movement takes place in parallel to the cut surface axis and/or angled to the cut surface axis and/or in a rotary manner. The cut surface axis extends in parallel to the direction of movement of the punch, but with respect to the workpiece.

Particularly preferably, the movable sensor unit is moved up to the height of the cut surface such that measurements may be carried out perpendicular to the cut surface axis or perpendicular to the cut surface. In particular, the sensor unit may be moved along the height of the cut surface and possibly beyond.

For this purpose, the sensor unit particularly preferably comprises a sensor lance with an optical measuring tip at the end of the sensor lance. With the sensor lance, the measuring tip, and thus the focus of the optical sensor unit, can be moved as close as possible and/or perpendicular to the cut surface.

Furthermore, the first processing machine preferably comprises a tool carrier. This tool carrier is configured to receive the at least one punch. Preferably, the tool carrier moves up and down with all the punches attached to it for carrying out the separating movement. According to a preferred embodiment, it is contemplated that the sensor unit is also arranged on the tool carrier and thus moves together with the tool carrier. As a result, the sensor unit is located as close as possible to the cut surfaces to be detected and may preferably be moved up to the height of the cut surface by the movement of the tool carrier.

Furthermore, the punch preferably presses the punched piece out of the workpiece into a hollow die. The sensor unit is located in the die and is thus able to detect the contour of the cut surface while the punched piece is in the hollow die. In particular, the punched piece is moved by the punch or by subsequent punched pieces through the hollow die. With this movement, the punch is guided past the sensor unit while the contour of the cut surface is detected.

In the context of the present invention, it is not absolutely necessary to cover the entire circumference of the cut surface. However, it is preferred that a sufficient part of the height of the cut surface (defined parallel to the cut surface axis) is covered. Preferably, the sensor unit detects at least 50%, preferably at least 75%, particularly preferably 95%, of the height of the cut surface. This makes it possible to detect crucial cut surface regions of the cut surface and to use them for evaluation.

In particular, the cut surface consists, along its height or along the cut surface axis, of an edge indentation region, a clear cut region, a fractured surface region and a burr region. It is particularly preferred to use the sensor unit to detect a plurality of these cut surface regions, preferably at least two or three of these cut surface regions.

The detection of the cut surface over a substantial part of its height is achieved by a correspondingly large detection angle of the sensor unit and/or by moving the sensor unit and/or by moving the workpiece.

In the following, advantageous configurations of the at least one sensor unit for detecting the contour of the cut surface on the workpiece are described. Since a plurality of sensor units may be used within the processing installation, the methods for optical detection described herein may also be combined in the method according to the invention.

In all configurations of the sensor unit, vibration may preferably be measured at the processing installation and/or the first processing machine and/or the workpiece, and the measured vibration may be taken into account when evaluating the detected optical data.

### Chromatic-Confocal Distance Measurement:

Preferably, the sensor unit is used to carry out a chromatic-confocal measurement of the distance to the cut surface.

The chromatic-confocal distance measurement uses the dispersion of white light in a focusing lens to determine the distance of a reflecting surface from the sensor. It therefore takes advantage of chromatic aberration.

### Digital Image Acquisition and Image Processing:

Preferably, the sensor unit is used to carry out digital 2D image acquisition of the cut surface, the contour being calculated by means of image processing, preferably an edge detection algorithm.

Preferably, the 2D image acquisition is carried out with at least one camera and at least one lighting unit.

The lighting unit and the associated camera are preferably arranged on different sides of the cut surface with respect to a plane perpendicular to the cut surface axis.

Alternatively, the lighting unit and the camera may also be arranged on the same side. In particular, the lighting unit is incorporated into the lens of the camera in this case.

The camera is preferably oriented at an angle α to a plane perpendicular to the axis of the cut surface, the angle α being at most 60°, preferably at most 50°, particularly preferably at most 40°.

The camera is preferably arranged on the side of the burr of the cut surface.

### Fringe Projection Method:

Preferably, the contour is detected with the sensor unit using the fringe projection method.

The fringe projection method is also referred to as stripe light optometry or stripe light scanning. The fringe projection sensor comprises a pattern projector and at least one camera. The pattern projector illuminates the measurement object sequentially with patterns of parallel bright and dark stripes of different widths. The camera(s) register the projected stripe pattern from a known viewing angle with respect to the projection. For each projection pattern, an image is taken with the camera(s). A temporal sequence of different brightness values is created for each pixel of all cameras.

### Light Section Method:

Preferably, the contour is detected with the sensor unit using the light section method.

The sensor unit preferably comprises a plurality of, preferably at least two or three, light section units, each with a light source and a light detector, which detect, preferably overlapping, regions of the cut surface.

The light section units are preferably arranged on different sides of the cut surface with respect to a plane perpendicular to the cut surface axis.

A light section sensor comprises a light section light source and at least one camera. The light section method is a method of optical 3D measurement technology that allows the measurement of a height profile along a projected light line. It is based on the principle of triangulation. The light section light source (usually using a laser as light source) projects a line which is as narrow and bright as possible onto the measurement object. The at least one camera observes the projection of the line on the object. The displacement of the line in the camera image is converted into 3D coordinates using the triangulation methods.

Combined Digital Image Acquisition with Light Section Source:

The sensor unit preferably comprises a camera and a light section light source, the camera being used for digital 2D image acquisition for subsequent image processing and as a light section light detector with subsequent evaluation according to the light section method. Preferably, lighting is used for 2D image acquisition.

The three optical axes of camera, illumination and light section light source are preferably in at least two different, non-parallel planes.

### Processing Installation for Detecting the Cut Surface:

The invention also comprises a processing installation. The processing installation is particularly configured to carry out the described method. The processing installation comprises the described first processing machine with the at least one movable punch for separating, preferably punching or punch broaching, the workpiece. Furthermore, the processing installation comprises at least one of the sensor units configured for non-contact, in particular optical, detection of a contour of the cut surface. The sensor unit is configured to detect the contour of the cut surface in-line in the processing installation.

In particular, the configuration of the processing machine and the definition of the processing installation have already been described in detail with reference to the method. The advantageous embodiments and dependent claims described in the context of the method according to the invention can correspondingly be advantageously applied to the processing installation according to the invention.

In particular, it is contemplated that the processing installation is configured such that the workpiece can be moved in the processing installation with a transport means while being detected by the sensor unit.

Furthermore, the processing installation preferably comprises a hollow die opposite the punch, the sensor unit being arranged in the hollow die.

Furthermore, the sensor unit is preferably arranged movably on the processing installation for detecting the cut surface. In particular, the sensor unit is connected to at least one actuator that moves the sensor unit.

The first processing machine of the processing installation preferably comprises a tool carrier for receiving the at least one punch. The sensor unit is preferably attached to the tool carrier.

### Method and Processing Machine for Detecting an Active Surface of a Punch:

The invention further comprises a method for operating the processing machine, the active surface of the punch being detected in-line, i.e., during production with the processing machine.

As already described, the processing machine comprises a movable punch. In the “method or processing machine for detecting the active surface of a punch”, the punch may be used to cut and/or form a workpiece. Thus, it is preferably a punch, punch-broaching punch, bending punch or embossing punch. The “active surface” contacts the workpiece during processing. The “active surface” is, for example, a cutting edge on the punch or punch-broaching punch or a forming edge, possibly with a corresponding radius, on the bending punch or embossing punch.

At least one sensor unit is installed on the processing machine. Using the sensor unit, the active surface, in particular a contour of the active surface, of the punch can be detected without removing the punch from the processing machine.

The condition of the active surface is evaluated based on the data detected by the sensor unit. The conclusions described above cannot only be drawn based on the condition of the cut surface, but also based on the condition of the active surface. This makes it possible to assess the quality of the parts produced, to assess the wear on the active surface and, if necessary, to control the processing machine accordingly.

Subsequent to the detection of the contour of the active surface, the condition of the active surface is evaluated based on the data detected by the sensor unit. Different conclusions can be drawn based on the evaluated condition of the active surface: for example, it is possible to assess the quality of the parts produced based on the active surface, causing, for example, the discarding of individual parts. Furthermore, it is contemplated to infer the quality of the active surface of the punch based on the active surface. Thereby, wear on the active surface may be determined. Furthermore, the processing machine may be controlled differently based on the condition of the active surface: for example, the cycle of the processing machine may be changed. The in-line measurement according to the invention makes it possible to determine the condition of the active surface during production with the processing machine, to draw the conclusions described and to take appropriate measures in-line.

It is particularly preferred to evaluate the data detected with the at least one sensor unit in a computing unit. The processing machine is particularly preferably controlled by the computing unit and based on the evaluated condition of the active surface.

Preferably, the sensor unit detects the contour of the active surface in synchronization with the movement of the punch performing the separation or the forming. The detection is performed by the sensor unit while the punch is being moved in a clocked manner and/or between two clocked movements. The punch of the processing machine is moved, for example, at a rate of 50 per minute or faster. The sensor unit particularly preferably detects the contour at least every 100th cycle, preferably at least every 50th cycle, particularly preferably at least every 10th cycle, further preferably at least every cycle.

In addition, the processing machine may comprise at least one sensor unit for detecting the cut surface on the workpiece, as has already been described in detail.

The optical methods for non-contact detection already described may be used to detect the active surface of the punch.

Particularly preferably, the sensor unit for detecting the active surface is incorporated into the tool carrier. Preferably, a relative movement between the active surface to be detected and the sensor unit takes place within the tool carrier such that the active surface can be detected across a substantial portion of its height.

Furthermore, the invention comprises a processing machine, the processing machine being in particular configured to carry out the method of detecting the active surface. For this purpose, the processing machine comprises at least one movable punch for separating and/or forming the workpiece and at least one sensor unit on the processing machine. The sensor unit is configured to detect the active surface of the punch without contact. Furthermore, the sensor unit is arranged such that the detection can be performed during production with the processing machine.

Further details, advantages and features of the present invention are apparent from the following description of exemplary embodiments with reference to the drawing. In the figures:

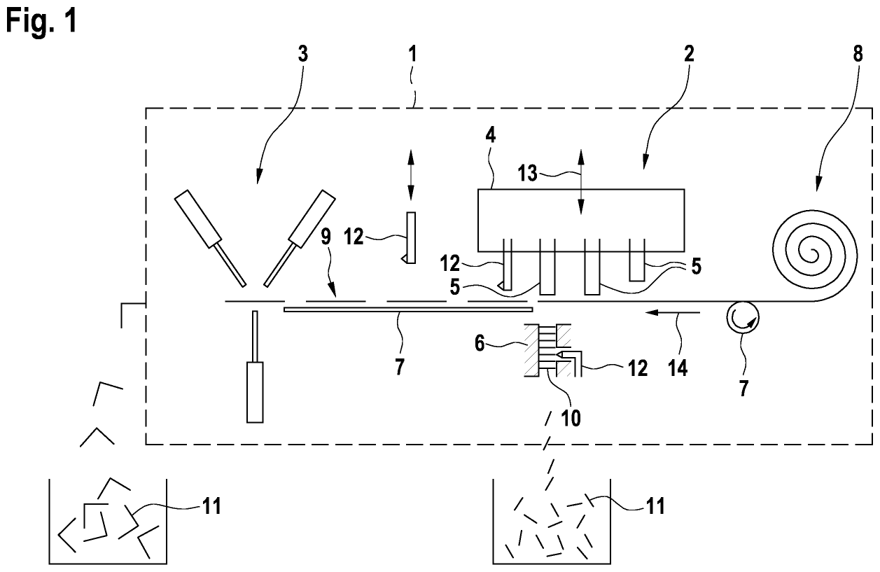

FIG. 1 is a schematic view of a processing installation according to the invention for carrying out the method of detecting the cut surface according to the invention,

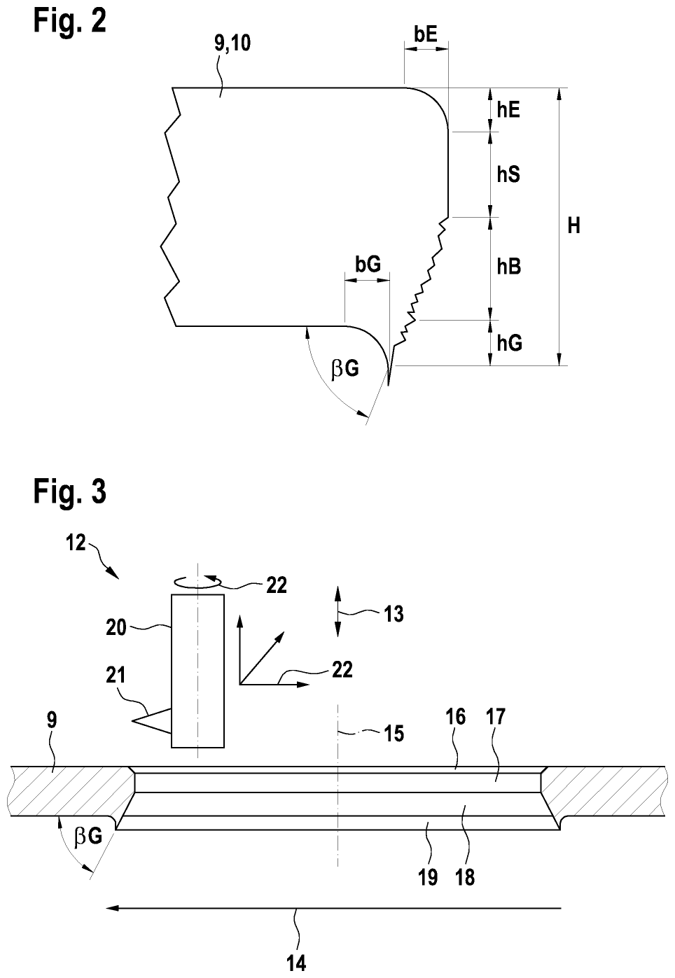

FIG. 2 shows a cut surface,

FIG. 3 shows a punched strip and a sensor unit in accordance with the method according to the invention,

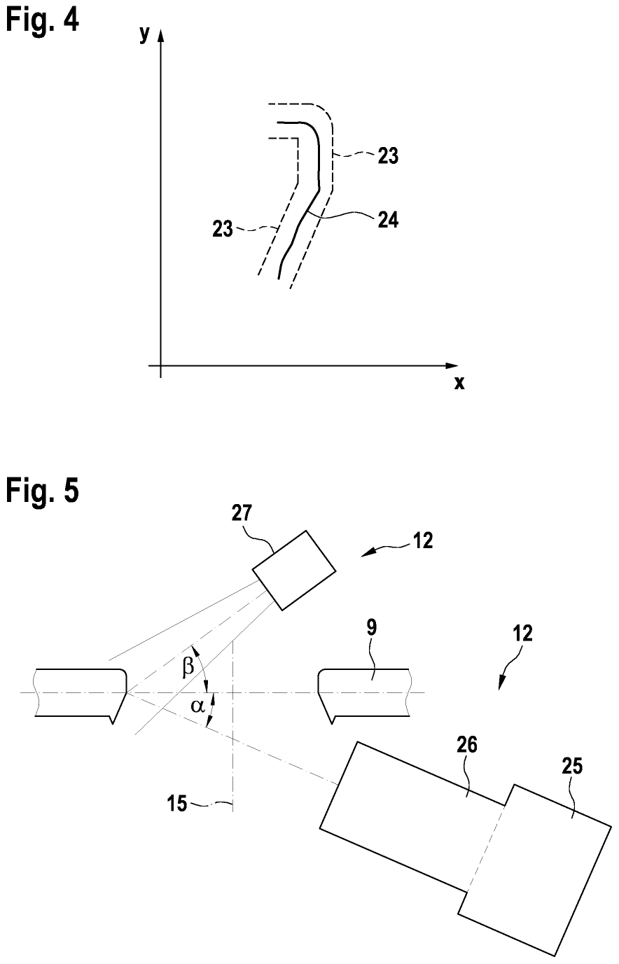

FIG. 4 shows a schematic evaluation of the condition of the cut surface in accordance with the method according to the invention,

FIG. 5 shows a schematic illustration of optical detection in accordance with the method according to the invention,

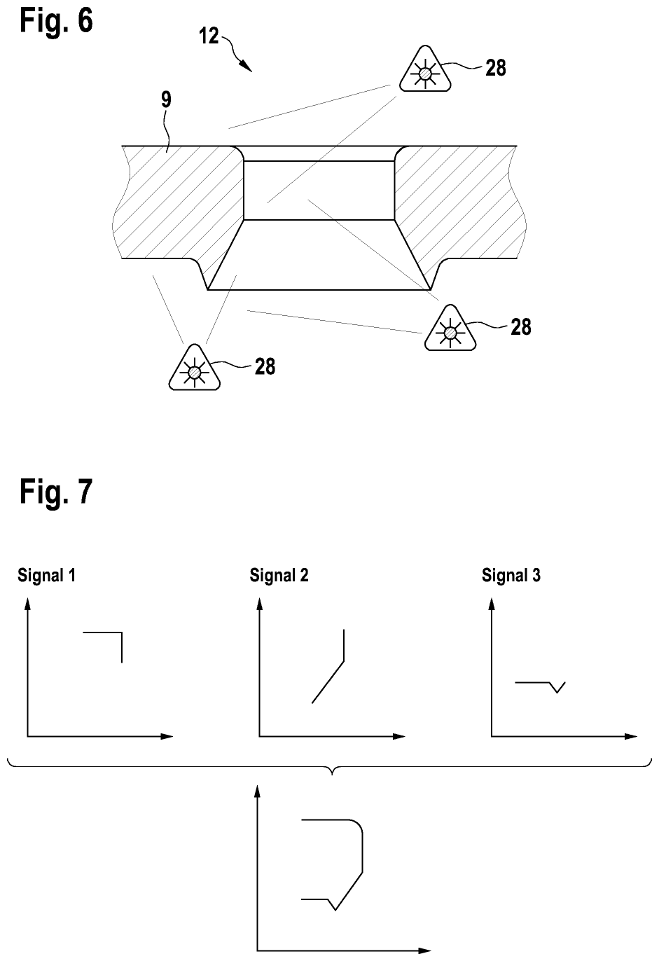

FIG. 6 shows a further schematic illustration of optical detection in accordance with the method according to the invention,

FIG. 7 shows a schematic evaluation for optical detection according to FIG. 6,

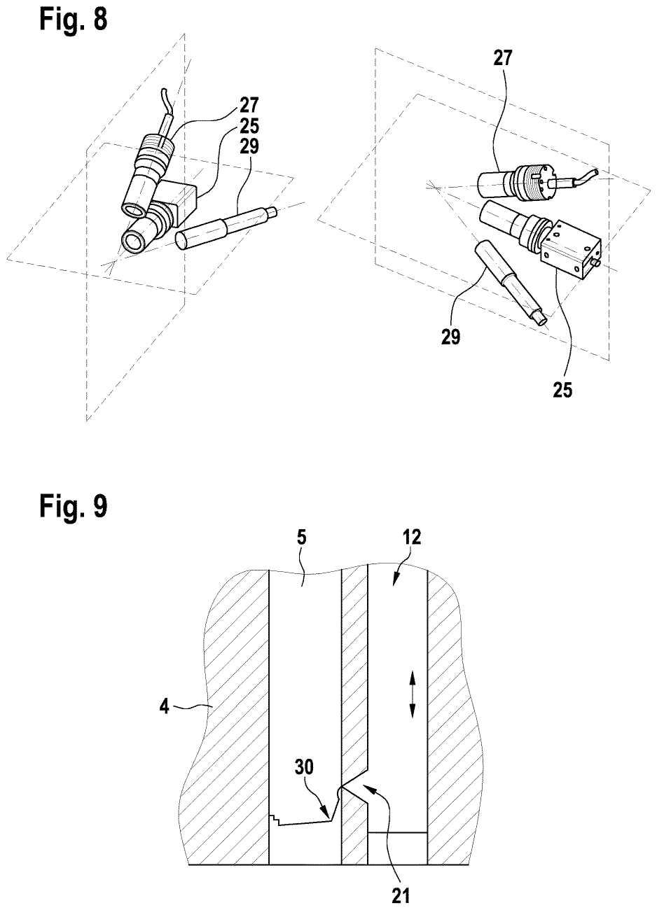

FIG. 8 shows a further schematic illustration of optical detection in accordance with the method according to the invention, and

FIG. 9 shows a detailed schematic illustration of a processing machine according to the invention for carrying out the method for detecting the active surface according to the invention.

FIG. 1 shows a schematic view of a processing installation 1 according to the invention for carrying out the method according to the invention.

The processing installation 1 comprises a first processing machine 2 and a further processing machine 3. The first processing machine 2 is configured as a punching machine. The further processing machine 3 is configured as a bending machine.

The processing machine 2 comprises a movable tool carrier 4 having a plurality of punches 5 for punching a workpiece 8 made of sheet metal. The tool carrier 4 moves with the punches 5 along the direction of movement 13 illustrated. Merely schematically, a die 6 is shown opposite a punch 5. In fact, the processing machine 2 may have a plurality of dies.

The first processing installation 1 comprises a transport means 7. The workpiece 8 is transported by the first processing machine 2 by means of the transport means 7. In the first processing machine 2, the workpiece 8 is separated into punched strips 9 and punched pieces 10. The punched pieces 10 are pressed into the hollow die 6 by the punch 5. The subsequent punched pieces 10 push the punched pieces 10 through the die 6, so that the punched pieces 10 fall out on the bottom of the die 6. Thus, the punched pieces 10 move through the hollow die 6 in synchronization with the punching first processing machine 2.

The punched strips 9 are transported individually (or as a continuous punched strip) and in synchronization to the further processing machine 3 by means of the transport means 7. The transport with the transport means 7 takes place along the indicated conveying direction 14. The punched strips 9 are bent in the further processing machine 3 and then leave the processing installation 1.

FIG. 1 shows the system boundary of the processing installation 1. Within the processing installation 1, the punched strips 9 and punched pieces 10 are moved in an orderly manner according to the cycle of the punching machine. Only after leaving the processing installation 1, the punched strips 9 and punched pieces 10 are stored as bulk material 11.

FIG. 1 shows three different positions for the arrangement of a sensor unit 12. In the processing installation 1, at least one sensor unit 12 may be employed in one or more of the positions.

The punching produces a cut surface on the punched strip 9 and on the punched piece 10. The sensor unit 12 is configured to detect the cut surface without contact, in particular optically. The cut surfaces are detected in-line in the operating processing installation 1.

FIG. 1 shows, between the first processing machine 2 and the further processing machine 3, a sensor unit 12 for detecting the contour of the cut surface on the punched strip 9. Depending on the configuration of the sensor unit 12, it is contemplated that the sensor unit 12 is arranged fixedly or movably at this location.

FIG. 1 shows a sensor unit 12 on the tool carrier 4. In particular, this sensor unit 12 is moved together with the tool carrier 4 along the direction of movement 13. In particular, this allows for the sensor unit 12 to be moved up to the height of the punched strip 9 and thus makes it possible to measure at right angles to the cut surface axis 12 or at right angles to the cut surface. However, it is also possible to configure the sensor unit 12 on the tool carrier 4 such that the sensor unit 12 does not have to be moved up to the punched strip 9, but rather is only moved as close as possible to the cut surface to be measured.

FIG. 1 shows, in the die 6, a sensor unit 12 for detecting the contour of the cut surface on the punched pieces 10. In particular, it is useful for this measurement that the punched pieces 10 move through the hollow die 6. As a result, the cut surface can be detected along the full height of the punched piece 10 with the sensor unit 12.

FIG. 2 shows a schematic view of a cut surface detected by the sensor unit 12. Particularly, the following parameters are characteristic for the cut surface or the contour of the cut surface: cut surface height H, edge indentation height hE, edge indentation width bE, smooth cut height hS, fractured surface height hB, burr height hG, burr width bG, fractured surface angle βG. In addition to this, the illustration in FIG. 3 shows the division of the cut surface into an edge indentation region 16, a smooth cut region 17, a fractured surface region 18 and a burr region 19. The cut surface axis 15, which is defined based on the direction of movement 13 of the punch 5, is illustrated on the punched strip 9. The four regions extend over the height H of the cut surface.

FIG. 3 also shows a sensor unit 12 having a sensor lance 20 and an optical measuring tip 21. The optical measuring tip 21 shows, purely schematically, the optical path and the focus of the sensor unit 12. If the sensor unit 12 is configured to be movable, it may move, for example, along the degrees of freedom 22 illustrated. This makes it possible to move the measuring tip 21 up to the height of the punched strip 9. The entire height H of the cut surface may be measured by means of this movement. Furthermore, it is possible to rotate the sensor unit 12 such that the cut surface is not only detected on one line. As already described, however, it is also possible to use a fixedly installed sensor unit 12.

FIG. 4 shows an example of how the evaluation of the detected data of the sensor unit 12 may be performed. For example, the detected contour 24 of the cut surface may be compared with an envelope curve 23. The conclusions, for example on the wear of the punch, can be drawn with a corresponding deviation of the detected contour 24 from the envelope 23. However, the evaluation may also be carried out in any other way, in particular by comparing the detected contour 24 with comparison values stored in a computing unit.

FIGS. 5 to 8 show schematic structures of the sensor unit 12. These sensor units 12 may preferably be installed fixedly and do not have to be moved for detecting the cut surfaces.

FIG. 5 shows a sensor unit 12 comprising a camera 25 with an objective 26 and lighting 27. The camera 25 and the lighting 27 are located on two different sides of the workpiece 8. With respect to a plane perpendicular to the cut surface axis 15, the camera 25 is oriented at a camera angle α and the lighting 27 is oriented at a lighting angle β.

The camera 25 and the lighting 27 are arranged statically and do not have to be moved into the punching opening for the measurement. With this measuring system, the cut surface is detected in-line and evaluated using digital image processing. In particular, with the aid of edge detection algorithms, the transitions, e.g. between the edge indentation region 16, the smooth cut region 17, the fractured surface region 18 and the burr region 19, are recognized and evaluated. Due to the integration into the process, changes in the surface characteristics over time may be recognized and trends may be defined. This allows conclusions to be drawn about the quality of the components and the state of wear of the punch 5. By specifying the quality parameters accordingly, parts can be marked as deficient and automatically recognized. Furthermore, countermeasures for the punch 5 may be inferred and adapted manually or by an automatic control system during the ongoing process.

Since, with this static structure, the cut surface to be imaged is oblique and not at right angles to the optical axis of the camera 25, the so-called Scheimpflug condition is violated. As a result, the usable depth of field is reduced and one may not be able to image the entire cut surface in focus. This disruptive effect may preferably be reduced by (i) restoring the Scheimpflug condition, e.g. with the aid of a special Scheimpflug lens; and/or (ii) by minimizing the negative effect of the violation of the Scheimpflug condition by choosing a camera angle α for the camera 25 that is as flat as possible; and/or (iii) by installing the camera 25 on the side of the fractured surface region 18 or burr region 19 of the cut surface, since these regions tend to face more towards the camera 25 for this camera arrangement due to the geometric shape.

The camera 25 with the objective 26 and the lighting 27 is preferably arranged in such a way that high-contrast images are obtained with regard to the features to be examined. In particular, different lighting configurations such as axial lighting or incident lighting (as shown in FIG. 5) can be used. With incident lighting, the lighting angle β may in particular be optimized such that the features to be detected are imaged with maximum contrast.

Depending on the application and the material, color filters and/or polarization filters and/or monochromatic lighting with a specifically selected light wavelength may preferably be used. Flashing lighting may also be advantageous, in particular in order to achieve short exposure times.

Since the workpiece 8 moves past the sensor unit 12 due to its natural feed movement within the manufacturing process, this movement may also be used to detect a larger image area. To do this, an entire image sequence has to be captured during the movement and image processing has to be used to calculate an effectively larger image with a correspondingly larger coverage of the entire cut surface. The quality and geometry features may then be recognized therefrom.

FIG. 6 shows sensor units 12 as light section sensors 28. The structure consists of one or more optical light section sensors 28 based on the principle of laser triangulation.

The light section sensors 28 are preferably arranged statically and thus do not move when the cut surface is detected. With the light section sensors 28, a measurement is carried out along a vertical line over the cut surface, similar to the case of the movable sensor unit 12. Since this static structure does not allow the sensor to be positioned directly vertically above the cut surface, it may be necessary to arrange several light section sensors (see FIG. 6) such that as large a portion of the contour as possible can be obtained by combining all measurement signals. For this purpose, the light section sensors 28 are oriented at different angles and their spatial arrangement may also be below and above the workpiece 8. Corresponding scanning geometries are projected onto the test part surface by the light section sensors 28 and their reflections are detected, the contour is calculated and then superimposed to form an overall profile, as shown in FIG. 7.

As already described, the movement of the workpiece 8 may be used again with this method and thus a 3D contour of the cut surface may be calculated. It is also contemplated that the laser triangulation sensors (light section sensors 28) are replaced by fringe projection sensors.

FIG. 8 shows a sensor unit 12 consisting of one or more light section light sources 29 projecting a thin straight laser light line onto the cut surface, a camera 25 with an objective 26 and a lighting unit 27. This measurement setup is preferably arranged statically and does not have to be moved into the punching opening for the measurement. This arrangement is used for combined digital image acquisition with a light section source. The camera 25 is used for 2D image acquisition as well as for light section measurement.

The lighting unit and the laser lines are preferably switched on and off in succession and an image is detected with the camera 25. A profile of the cut surface may then be calculated from the image detecting with the laser line lighting, analogous to the light section method, using the triangulation algorithm. The surfaces may also be moved and the image may be captured at high frequency. In this way, the topography of the surface may be detected.

It may be necessary to switch off the lighting and to separate the image detecting without a laser unit from the image detecting with a laser unit in time. However, preferably this may also be simultaneous.

FIG. 9 shows a section of the first processing machine 2 with an arrangement for detecting an active surface 30 on the punch 5, in particular a cutting edge on the punch. For this purpose, the relative movement between the punch 5 and a guide plate of the tool carrier 4 is used to measure the worn active surface 30 of the punch 5. An optional separate drive of the sensor unit 12 may be implemented by means of various drives.

### LIST OF REFERENCE SYMBOLS

1 processing installation
2 first processing machine
3 further processing machine
4 tool carrier
5 punch
6 die
7 transport means
8 workpiece
9 punched strip
10 punched piece
11 bulk material
12 sensor unit
13 direction of movement
14 conveying direction
15 cut surface axis
16 edge indentation region
17 smooth cut region
18 fractured surface region
19 burr region
20 sensor lance
21 measuring tip
22 degrees of freedom
23 envelope
24 contour
25 camera
26 objective
27 lighting
α camera angle
β lighting angle
28 light section sensor
29 light section light source
30 cutting edge
H cut surface height
hE edge indentation height
bE edge indentation width
hS smooth cut height
hB fractured surface height
hG burr height
bG burr width
βG fractured surface angle

1. A method for operating a processing installation including a first processing machine, said first processing machine comprising at least one movable punch for separating, preferably punching or punch broaching, a workpiece, said method comprising the following steps:
contactlessly detecting a contour of a cut surface produced on said workpiece by said punch by means of at least one sensor unit mounted on said processing installation, wherein the detecting is performed in-line in said processing installation and consequently without removing said workpiece from said processing installation, and
evaluating the condition of the cut surface on the basis of the data detected by said sensor unit.

2. The method according to claim 1, wherein said workpiece is moved during detecting by said sensor unit in said processing installation and/or rests between two clocked movements.

3. The method according to claim 1, wherein
said punch separates said workpiece into a punched strip and a punched piece,
said workpiece is transported in said processing installation by means of a transport means through said first processing machine and, after said first processing machine, said punched strip is transported to a further processing machine or an end of said processing installation, and
wherein said sensor unit detects the contour of the cut surface while said punched strip is moved by means of said transport means and/or rests on said transport means between two clocked movements.

4. The method according to claim 1, wherein said sensor unit is moved for detecting the cut surface in parallel to a cut surface axis and/or angled to the cut surface axis and/or in a rotatory manner.

5. The method according to claim 1, wherein said first processing machine comprises a tool carrier for receiving said at least one punch, said sensor unit being arranged on said tool carrier.

6. The method according to claim 1, wherein said punch presses a punched piece from said workpiece into a hollow die, wherein said sensor unit detects the contour of the cut surface while said punched piece is located in said hollow die.

7. The method according to claim 1, wherein the cut surface has a height parallel to a cut surface axis, wherein at least 50% of said height of the cut surface is detected with said sensor unit and then evaluated.

8. The method according to claim 1, wherein a plurality of cut surface regions of the cut surface are detected and then evaluated with said sensor unit; and wherein the plurality of cut surface regions comprise an edge indentation region and/or a smooth cut region and/or ta fractured surface region and/or a burr region.

9. The method according to claim 1, wherein the detected data of said at least one sensor unit are evaluated in a computing unit, and wherein said processing installation, is controlled by said computing unit based on the condition of the cut surface.

10. A processing installation for carrying out the method according to claim 1, comprising:
a first processing machine including at least one movable punch for separating a workpiece, and
at least one sensor unit on said processing installation which is configured to contactlessly detect a contour of a cut surface produced by said punch on said workpiece and which is arranged for detecting in-line in said processing installation.

11. The processing installation according to claim 10, wherein said workpiece is movable in said processing installation by means of a transport means during detecting by said sensor unit.

12. The processing installation according to claim 10, comprising a hollow die opposite said punch, said sensor unit being arranged in said hollow die.

13. The processing installation according to claim 10, wherein said sensor unit is movably arranged for detecting the cut surface.

14. The processing installation according to claim 10, wherein said first processing machine comprises a tool carrier for receiving said at least one punch, said sensor unit being arranged on said tool carrier.

15. A method for operating a processing machine, the processing machine comprising at least one movable punch for separating and/or forming a workpiece, said method comprising the following steps:
contactlessly detecting at least one active surface of said punch with a sensor unit mounted on said processing machine, wherein the detecting is performed during production with said processing machine and thus without removing said punch from said processing machine, and
evaluating the condition of said active surface based on the data detected by said sensor unit.

16. A processing machine for performing the method according to claim 15, comprising:
at least one movable punch for separating and/or forming a workpiece, and
at least one sensor unit on said processing machine which is configured to contactlessly detect at least one active surface of said punch and which is arranged for detecting during production with said processing machine.

17. The method according to claim 1, wherein contactlessly detecting the contour of the cut surface produced on said workpiece comprises optically detecting the contour.

18. The processing installation according to claim 10, wherein the at least one sensor unit is configured to optically detect the contour of the cut surface.

19. The method according to claim 15, wherein contactlessly detecting the at least one active surface of said punch comprises optically detecting the at least one active surface.

20. The processing machine of claim 16, wherein the at least one sensor unit is configured to optically detect the at least one active surface.
